(19) United States
(12) Patent Application Publication
(10) Pub. No.: US 2012/0141921 A1
(43) Pub. Date: Jun. 7, 2012

(54) MANUFACTURING METHOD OF FUEL CELL STACK

(75) Inventor: Kook Il Han, Seoul (KR)

(73) Assignee: HYUNDAI MOTOR COMPANY, Seoul (KR)

(21) Appl. No.: 13/188,704

(22) Filed: Jul. 22, 2011

(30) Foreign Application Priority Data
Dec. 7, 2010 (KR) 10-2010-0124415

(51) Int. Cl. H01M 8/00

(52) U.S. Cl. 429/535

(57) ABSTRACT

The present invention provides a joining method of a gas diffusion layer and an electrode membrane including a catalyst layer, a polymer electrolyte membrane, and a sub-gasket. In particular, the method provides a way to join the gas diffusion layer with the sub-gasket without hot-pressing the them together by forming a groove at a junction portion of the gas diffusion layer and the sub-gasket and inserting a stopper into this groove which is made of a material which hardens after being formed.

### CROSS-REFERENCE TO RELATED APPLICATION

This application claims priority to and the benefit of Korean Patent Application No. 10-2010-0124415 filed in the Korean Intellectual Property Office on Dec 7, 2010, the entire contents of which are incorporated herein by reference.

### BACKGROUND OF THE INVENTION

(a) Field of the Invention

The present invention relates to a connecting method of an electrode membrane and a gas diffusion layer for manufacturing a fuel cell stack. More particularly, the present invention relates to a method for connecting the electrode membrane and the gas diffusion layer by forming grooves in a region that does not participate in a fuel cell reaction in the gas diffusion layer and forming stoppers in the electrode membrane.

(b) Description of the Related Art

Generally, a fuel cell is a nonpolluting power supply apparatus that generates electricity by chemically-reacting fuel, particularly hydrogen with oxygen in the air, and is highlighted as one of the next clean energy systems. Generating systems using the fuel cell can be used as a generator of a large building or a power source of an electric vehicle. Advantageously, it can be used with a variety of fuels such as natural gas, city gas, etc.

The fuel cells are classified into a molten carbonate fuel cell (MCFC), a solid oxide fuel cell (SOFC), a polymer electrolyte fuel cell (PEFC), a phosphoric acid fuel cell (PAFC), and an alkaline fuel cell (AFC) according to a fundamentally used electrolyte. The electrode membrane (MEA, membrane electrolyte assembly) 10, as shown in FIG. 1, is composed of a catalyst layer 11, a polymer electrolyte membrane 12, and a sub-gasket 13. The sub-gasket 13 is introduced to handle the MEA.

The sub-gasket 10 is made of a polymer film such as PE and PEN that are inactive with regard to a fuel cell reaction. Because a gas diffusion layer (GDL) 20 is necessary in forming a lamination layer, unification of the MEA 10 and the gas diffusion layer 20 is needed. A catalyst coated membrane (CCM) in which the catalyst layer 11 is directly coated on the polymer electrolyte membrane 12 requires a joining step of the gas diffusion layer 20. This is shown in FIG. 2 A.

By other methods as shown in FIG. 2B, in addition to those described above, such as for a catalyst coated substrate (CCS) or catalyst coated GDL (CCG) in which the catalyst layer 11 is directly coated on the gas diffusion layer 20. The gas diffusion layer 20 is then joined with the electrode membrane 10 by hot-pressing. Because the MEA 10 is separated from the GDL in the CCM method, when multiple cell stacks are made by lamination, in particular, using automated equipment, the joining process of the MEA 10 and GDL 20 is indispensable.

As shown in FIG. 2C, according to the CCS method, the MEA 10 is joined with the GDL 20 by hot-pressing because the catalyst layer 11 and the polymer electrolyte membrane 12 are joined during manufacturing of the MEA 10. A joined MEA as described above is called a 5 layer MEA 110, and the MEA 10 is also called a 3 layer MEA. However, when the MEA 10 and the GDL 20 are temporarily fixed by hot-pressing in the CCM method, as shown in FIG. 3, an interface 15 between the catalyst layer 11 and the GDL 20 is formed, and an interface 16 between the sub-gasket 13 and the GDL 20 is formed.

The fuel cell reaction occurs at the interface 15 between the catalyst layer 11 and the GDL 20, but the interface 16 between the sub-gasket 13 and the GDL 20 is irrelevant to the fuel cell reaction. Also, an ionomer such as Nafion is typically coated on the GDL 20 by hot-pressing in order to improve an adhesive force. However, the expected performance can be different because the GDL interfaces 15 and 16 are hydrophilic. Also, a connector of the MEA 10 and GDL 20 cannot be stored in a non-engaged state for a long time because of the hot-pressing joiner procedure. This results from desorption among the GDL 20 in which sizes are changed according to the humidifying of the MEA 10 as humidification changes without additional engagement of adhesives.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a manufacturing method of a fuel cell stack which provides a method of joining an electrode membrane and a gas diffusion layer.

An exemplary embodiment of the present invention provides a joining method of a gas diffusion layer and an electrode membrane including a catalyst layer, a polymer electrolyte membrane, and a sub-gasket by forming a groove at a junction portion of the gas diffusion layer with the sub-gasket; and forming a stopper at the groove in order to join the gas diffusion layer and the sub-gasket.

The joining according to an exemplary embodiment of the present invention can be performed by hardening the stopper after the stopper is injected into the groove. More specifically, a stopper may be formed at the electrode membrane. The electrode membrane and the gas diffusion layer are then rolled in order to combine the stopper of the electrode membrane and the groove. Additionally, the electrode membrane may be overlapped with a portion of the gas diffusion layer that does not participate in a fuel cell reaction.

The stopper according to an exemplary embodiment of the present invention can be made of a polymer with high viscosity or a material that is hardens after being formed. In addition, the height of the stopper should preferably not be higher than the height of the gas diffusion layer surface after the electrode membrane is joined to the gas diffusion layer. The stopper can also be coated with an adhesive. In particular, the stopper may only penetrate the gas diffusion layer and should preferably not penetrate the sub-gasket while at the same time being integrally formed at the surface of the sub-gasket.

As described above, an exemplary embodiment of the present invention does not adopt the hot-pressing method, so adhesive force does not get worse in spite of long term storage. Furthermore, when the fuel cells are stacked, the joining time of the electrode layer and the gas diffusion layer can be shortened, so the supply time of the stack can be reduced. In addition, consumed energy can be reduced.

### BRIEF DESCRIPTION OF THE DRAWINGS

FIG. 1 is a schematic view of an electrode membrane.

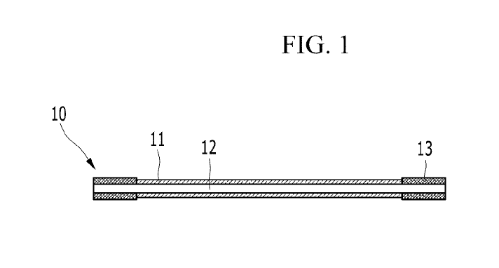

FIG. 2 is a schematic view for explaining a conventional joining method of an electrode membrane and a gas diffusion layer.

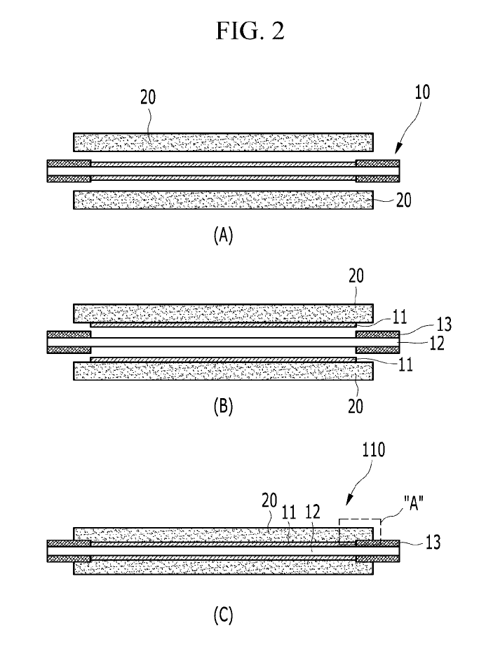

FIG. 3 is an enlarged view of FIG. 2A.

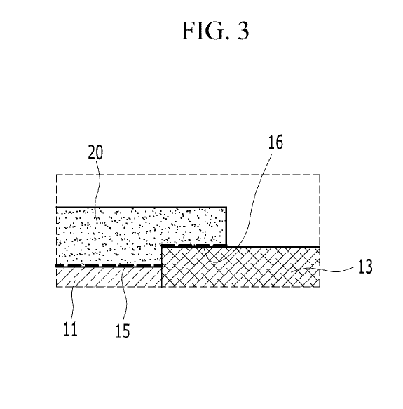

FIG. 4 is a schematic view of conjoining elements according to an exemplary embodiment of the present invention.

FIG. 5 is a joining process view showing a joined portion of an electrode and a gas diffusion layer according to an exemplary embodiment of the present invention.

FIG. 6 is a joining process view of an electrode membrane and a gas diffusion layer according to an exemplary embodiment of the present invention.

### DETAILED DESCRIPTION OF THE EMBODIMENTS

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

An exemplary embodiment of the present invention relates to a joining method of a gas diffusion layer (GDL) 20 and an electrode membrane (MEA, membrane electrolyte assembly) 10 including a catalyst layer 11, a polymer electrolyte membrane 12 and sub-gaskets 13 for a fuel cell stack, and in particular, a joining method of the MEA 10 and GDL 20 using a CCM method.

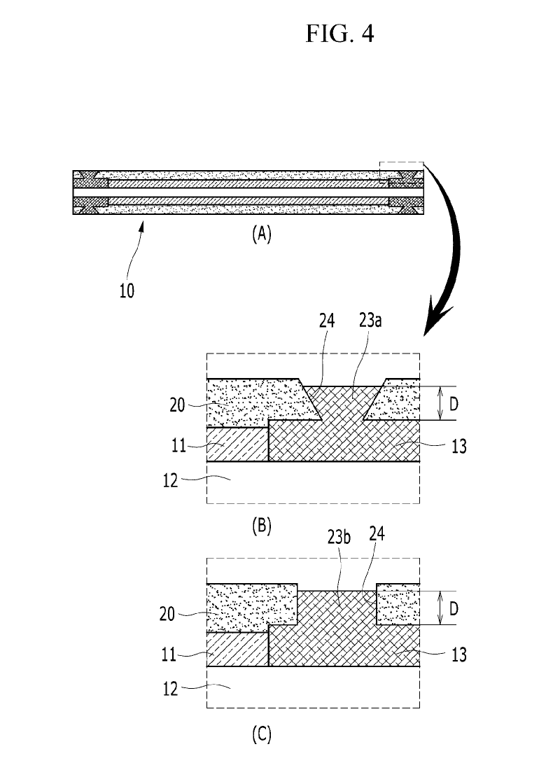

First, FIG. 4A is a cross-sectional view of the MEA 10 and GDL 20 joined together according to an exemplary embodiment of the present invention, wherein a groove 24 is formed within a region that is irrelevant to/does not participate in a fuel cell reaction of the GDL 20, and a stopper in the shape of a cut cone 23a or a stopper in the shape of a cylinder 23b is formed at the groove 24.

As described above, the groove 24 should preferably be formed at a joining portion with the sub-gasket 13 in order to join the MEA 10 and the GDL 20, and the stopper 23 should preferably be formed in the groove 24. Hereinafter, two methods will be described.

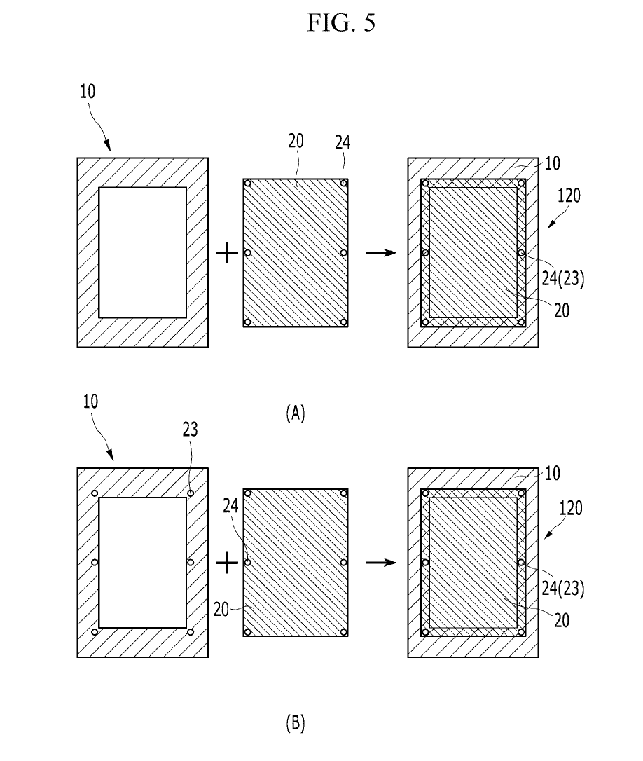

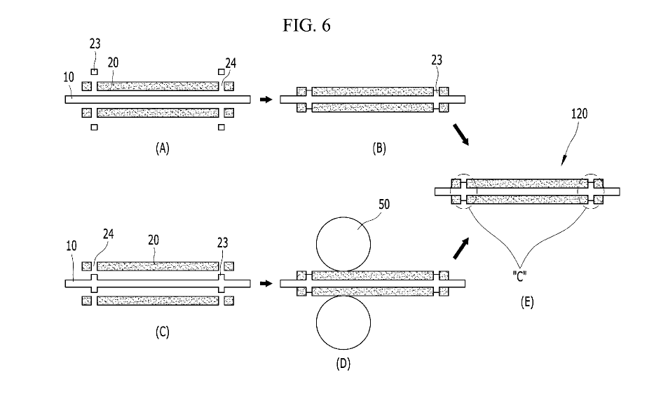

The first exemplary embodiment according to the present invention is a method in which the stopper 23 is hardened after it is injected into the groove 24, and this is shown in FIG. 5A and FIG. 6A and 6B.

FIG. 5 is a joining process view of the MEA 10 and the GDL 20 according to the first exemplary embodiment of the present invention. First, the groove 24 is formed by punching the GDL 20. The GDL 20 formed with the groove 24 is then overlapped with the MEA 10, and a polymer liquid having a high viscosity is poured into the groove 24 and a stopper 23 is formed by hardening the liquid. The polymer-liquid joins the MEA 10 and the GDL 20. The polymer liquid is made of the same material as the sub-gasket 13, and has an affinity with the sub-gasket 13. The polymer liquid is thus preferably a material that hardens after being formed or is an adhesive material such as rubber. At this point in the process, an exterior force does not exist between the MEA 10 and the GDL 20, and the groove 24 can be formed in various shapes.

The overlapped region between the MEA 10 and the GDL 20 is a portion of the region that is irrelevant to/does not participate in the fuel cell reaction. The stopper 23 stops the GDL 20 from being excessively pressed so that the porous GDL 20 can be maintained at a predetermined thickness and be protected against deterioration or an unexpected rise of fastening pressure in a stack. This means that the stopper 23 should preferably be formed below a critical thickness, so that the stopper is not deformed when the GDL 20 imparts an influence on the fuel cell. This is the same in the following second exemplary embodiment. Notably, the above joined MEA may also be called a 5 layer MEA 120.

FIGS. 6A and 6B are joining process views of the MEA 10 and GDL 20 according to the first exemplary embodiment of the present invention, wherein the polymer liquid with high viscosity is injected into the groove 24 of the GDL 20, and the polymer liquid becomes a stopper 23 after the polymer liquid is hardened. Accordingly, the MEA 10 and the GDL 20 are joined to each other due to the harden formation created by the stopper 23. At this time, the stopper 23 performs the function of an adhesive, without having to apply pressure to the layers.

A method according to the second exemplary embodiment is shown in FIG. 5B, FIG. 6C, and 6D. First, FIG. 5B is a joining process view of the MEA 10 and the GDL 20 according to the second exemplary embodiment of the present invention, and in this case the groove 24 is also firstly formed in the GDL 20. After the groove 24 is formed in the GDL 20, positively protruded stoppers 23a and 23b are formed in the MEA 10, and the MEA 10 and the GDL 20 are joined by a rolling process. That is, the positively protruded stopper 23 formed in the MEA 10 is inserted into the groove 24 of the GDL 20 and is pressed so the MEA 10 and the GDL 20 can be joined. FIG. 6C and 6D are joining process views of the MEA 10 and GDL 20 according to the second exemplary embodiment of the present invention, and it can be seen that the MEA 10 can be joined with the GDL 20 by rolling of a roller 50. In this case, the stopper 23 is made of the same material as the sub-gasket 13, it is a polymer having an affinity with the sub-gasket 13, and is a material that hardens after being formed or an adhesive material such as rubber like the first exemplary embodiment.

The stopper 23, in joining methods of the MEA 10 and the GDL 20 according to the first and second exemplary embodiments, is preferably filled to a height such that the GDL 20 is not excessively deformed. To achieve this, the stopper 23 after the MEA 10 and the GDL 20 is joined should not protrude over the surface of the GDL 20. The final shape of the stopper 23 according to the first and second exemplary embodiment is the same. Illustratively, D in FIG. 4 is a height at which the GDL 20 does not influence the fuel cell performance and is not deformed to below a critical thickness.

Also, the stopper 23 in the second embodiment may be coated with an adhesive so adhesion can be improved. The stopper 23 thus only penetrates the GDL 20 and does not penetrate the sub-gasket 13, and in addition, the stopper 23 can be integrally formed on the surface of the sub-gasket 13. C in FIG. 6E indicates a joined portion fixed by joining according to the first and second exemplary embodiments.

Also, in the joining method according to the first and second exemplary embodiments, the MEA 10 is overlapped with a portion of the region that is irrelevant to/does not participate in the fuel cell reaction, and the stopper 23 is again preferably made of a polymer material with high viscosity.

If the viscosity of the polymer liquid is excessively low, because the polymer liquid permeates the porous GDL 20, the adhesion is deteriorated. On the other hand, if the viscosity of the polymer liquid is excessively high, because a step at the adhesive surface is produced, the contact resistance can be increased due to poor surface pressure between the catalyst layer 11 and the GDL 20. Therefore, in the exemplary embodiment of the present invention, a thermoplastic adhesive (in particular, a solvent adhesive) such as cellulose acetate, cellulose acetate butyrate, cellulose nitrate, polyvinyl acetate, vinyl vinylidene, polyvinyl acetals, polyvinyl alcohol, polyamide, acrylic, phenoxy, etc. can be used for the stopper 23 by adjusting the viscosity.

Also, in the exemplary embodiment of the present invention, a thermosetting adhesive (in particular, a solvent adhesive) such as cyanoacrylate, polyester, urea formaldehyde, resorcinol and phenol-resorcinol formaldehyde, epoxy, polyimide, acrylic, acrylate acid diester, etc. can be used for the stopper 23 by adjusting the viscosity.

In addition, in the exemplary embodiment of the present invention, an elastomeric adhesive (in particular, a solvent adhesives) such as natural rubber, reclaimed rubber, butyl, polyisobutylene, nitrile, styrene butadiene, polyurethane, polysulfide, silicone, neoprene, etc. can be used for the stopper 23 by adjusting the viscosity.

By the above process, as shown in FIG. 6E, the MEA 10 can be joined and fixed with the GDL 20 firmly.

According to the present invention, the MEA 10 and the GDL 20 are joined without hot-pressing, so an additional joining process is not necessary. Therefore, the joining time can be reduced, and foreign substances do not exist on the interface 15 between the catalyst layer 11 and the GDL 20.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A joining method of a gas diffusion layer and an electrode membrane comprising a catalyst layer, a polymer electrolyte membrane, and a sub-gasket comprising:
forming a groove at a junction portion of the gas diffusion layer with the sub-gasket; and
forming a stopper within the groove in order to join the gas diffusion layer with the sub-gasket without hot-pressing the gas diffusion layer and the sub-gasket together.

2. A joining method of claim 1, wherein the joining is performed by hardening the stopper after the stopper is injected into the groove.

3. A joining method of claim 1, wherein the joining further comprises:
forming a stopper at the electrode membrane; and rolling the electrode membrane and the gas diffusion layer in order to combine the stopper of the electrode membrane and the groove.

4. A joining method of claim 2, wherein the joining further comprises overlapping the electrode membrane with a portion of the gas diffusion layer that does not participate in a fuel cell reaction.

5. A joining method of claim 3, wherein the joining is performed by overlapping the electrode membrane and a portion of the gas diffusion layer that does not participate in a fuel cell reaction.

6. A joining method of claim 2, wherein the stopper is made of a polymer with a high viscosity or a material that hardens after being formed.

7. A joining method of claim 3, wherein the stopper is made of a polymer with high viscosity or a material that is hardened after being formed.

8. A joining method of claim 2, wherein the height of the stopper is not higher than the height of the gas diffusion layer surface after the electrode membrane is joined to the gas diffusion layer.

9. A joining method of claim 3, wherein the height of the stopper is not higher than the height of the gas diffusion layer surface after the electrode membrane is joined to the gas diffusion layer.

10. A joining method of claim 3, wherein the stopper is coated with an adhesive.

11. A joining method of claim 2, wherein the stopper penetrates just the gas diffusion layer and does not penetrate the sub-gasket, and is integrally formed at the surface of the sub-gasket.

12. A joining method of claim 3, wherein the stopper penetrates just the gas diffusion layer and does not penetrate the sub-gasket, and is integrally formed at the surface of the sub-gasket.
